(19) United States
(12) Patent Application Publication
(10) Pub. No.: US 2012/0219805 A1
(43) Pub. Date: Aug. 30, 2012

(54) PROCESS FOR PRODUCING LOW VOC COATING COMPOSITIONS

(75) Inventors: AYUMU YOKOYAMA, WALLINGFORD, PA (US); HARI BABU SUNKARA, HOCKESSIN, DE (US); RAJESH GOPALAN SALIYA, PHILADELPHIA, PA (US); KARLIS ADAMSONS, GREENVILLE, DE (US)

(73) Assignee: E. I. DU PONT DE NEMOURS AND COMPANY, Wilmington, DE (US)

(21) Appl. No.: 13/400,196

(22) Filed: Feb. 20, 2012

Related U.S. Application Data
(60) Provisional application No. 61/446,250, filed on Feb. 24, 2011.

(51) Int. Cl. C08L 75/06; B32B 27/40; B05D 3/02; C08L 75/04

(52) U.S. Cl. 428/423.1; 524/500; 524/507; 427/385.5; 427/393; 427/388.2; 427/393.5; 427/389.7; 427/391; 427/393.6

(57) ABSTRACT

The present invention is directed to a process for producing a low VOC (volatile organic compound) coating composition. The process can comprise mixing a solvent borne coating component and a low or zero VOC waterborne coating component in the presence of a low molecular weight polytrimethylene ether glycol. The present invention can be used to produce low VOC coatings for automotive original equipment manufacturing (OEM) and refinish coating applications, industrial coating applications on equipments and structures, or architectural coating applications on buildings or other structures. This disclosure is further directed to a coating composition comprising components derived from renewable resources.

### FIELD OF INVENTION

The present invention is directed to a process for producing a low VOC (volatile organic compound) coating composition. This disclosure is further directed to a coating composition comprising components derived from renewable resources.

### BACKGROUND OF INVENTION

Volatile organic compounds (VOCs) are compounds of carbon, which can emit into atmosphere and participate in atmospheric photochemical reactions. Many volatile organic compounds are commonly used in industrial products or processes, such as solvents, dispersants, carriers, coating compositions, molding compositions, cleaners, or aerosols. VOCs emitted into atmosphere, such as those emitted from coating compositions during coating manufacturing, application and curing process, can be related to air pollution impacting air quality, participate in photoreactions with air to form ozone, and contribute to urban smog and global warming.

Efforts have been made to reduce VOC emissions into the air. For example, the coating industry has been trying to develop low VOC coating compositions by using high solid content with reduced solvent contents, water, VOC exempt organic solvents or compounds. VOC exempt organic compounds can also be used to substitute or replace part or all VOCs in some industrial applications, such as coatings. The VOC exempt organic compounds are compounds of carbon and are believed not to participate in atmospheric photochemical reactions to form smog. Examples of VOC exempt organic compounds can include acetone, methyl acetate, and PCBTF (Oxsol 100). However, production of low VOC products or converting naturally occurring volatile organic compounds into VOC exempt organic compounds can require the consumption of additional materials and energy, which may in turn cause further increase in net output of other materials such as carbon dioxide that has been attributed to global warming.

Therefore, new processes for producing low VOC coating compositions are still needed.

### STATEMENT OF INVENTION

This disclosure is directed to a process for producing a coating composition, said process comprising the steps of:

(a) providing a first crosslinkable component comprising a first set of one or more film forming polymers and one or more organic solvents, said first crosslinkable component comprises in a range of from 10% to 80% weight percent of said one or more organic solvents, percentage based on the total weight of said first crosslinkable component;

(b) providing a second crosslinkable component comprising a second set of one or more film forming polymers and water, said second crosslinkable component comprises in a range of from 10% to 80% weight percent of water, percentage based on the total weight of said second crosslinkable component;

(c) providing a polytrimethylene ether glycol having a Mn (number average molecular weight) in a range of from 100 to 490; and

(d) producing said coating composition by mixing said first crosslinkable component, said second crosslinkable component, said polytrimethylene ether glycol, a crosslinking component, and optionally, an additive component.

This disclosure is also directed a process for producing a dry coating layer over a substrate, said process comprising the steps of:

(i) applying the coating composition of this disclosure over said substrate to form a wet coating layer thereon; and

(ii) curing said wet coating layer at a temperature in a range of from 15° C. to 80° C. to form said dry coating layer.

### DETAILED DESCRIPTION

The features and advantages of the present invention will be more readily understood, by those of ordinary skill in the art, from reading the following detailed description. It is to be appreciated that certain features of the invention, which are, for clarity, described above and below in the context of separate embodiments, may also be provided in combination in a single embodiment. Conversely, various features of the invention that are, for brevity, described in the context of a single embodiment, may also be provided separately or in any sub-combination. In addition, references in the singular may also include the plural (for example, “a” and “an” may refer to one, or one or more) unless the context specifically states otherwise.

The use of numerical values in the various ranges specified in this application, unless expressly indicated otherwise, are stated as approximations as though the minimum and maximum values within the stated ranges were both proceeded by the word “about.” In this manner, slight variations above and below the stated ranges can be used to achieve substantially the same results as values within the ranges. Also, the disclosure of these ranges is intended as a continuous range including every value between the minimum and maximum values.

As used herein:

The term “(meth)acrylate” means methacrylate or acrylate.

The term “two-pack coating composition”, also known as 2K coating composition, refers to a coating composition having two packages that are stored in separate containers and sealed to increase the shelf life of the coating composition during storage. The two packages are mixed just prior to use to form a pot mix, which has a limited pot life, typically ranging from a few minutes (15 minutes to 45 minutes) to a few hours (4 hours to 8 hours). The pot mix is then applied as a layer of a desired thickness on a substrate surface, such as an automobile body. After application, the layer dries and cures at ambient or at elevated temperatures to form a coating on the substrate surface having desired coating properties, such as, high gloss, mar-resistance and resistance to environmental etching.

The term “one-pack coating composition”, also known as 1K coating composition, refers to a coating composition having one package that is stored in one container and sealed to increase the shelf life of the coating composition during storage. The 1K coating composition can be formulated to be cured at certain curing conditions. Examples of such curing conditions can include: radiation, such as UV radiation including UV-A, UV-B, and UV-C radiations, electron beam (e-beam) radiation, infrared (IR) radiation, or lights in visible or invisible wavelengths; moisture, such as water accessible to the coating composition; thermal energy, such as high temperatures; or other chemical or physical conditions.

The term “crosslinkable component” refers to a component having “crosslinkable functional groups” that are functional groups positioned in the molecule of the compounds, oligomer, polymer, the backbone of the polymer, pendant from the backbone of the polymer, terminally positioned on the backbone of the polymer, or a combination thereof, wherein these functional groups are capable of crosslinking with crosslinking functional groups (during the curing step) to produce a coating in the form of crosslinked structures. One of ordinary skill in the art would recognize that certain crosslinkable functional group combinations would be excluded, since, if present, these combinations would crosslink among themselves (self-crosslink), thereby destroying their ability to crosslink with the crosslinking functional groups. A workable combination of crosslinkable functional groups refers to the combinations of crosslinkable functional groups that can be used in coating applications excluding those combinations that would self-crosslink.

Typical crosslinkable functional groups can include hydroxyl, thiol, isocyanate, thioisocyanate, acid or polyacid, acetoacetoxy, carboxyl, amine groups including primary amine and secondary amine, epoxy, anhydride, ketimine, aldimine, or a workable combination thereof. Some other functional groups such as orthoester, orthocarbonate, or cyclic amide that can generate hydroxyl or amine groups once the ring structure is opened can also be suitable as crosslinkable functional groups.

The term “crosslinking component” refers to a component having “crosslinking functional groups” that are functional groups positioned in the molecule of the compounds, oligomer, polymer, the backbone of the polymer, pendant from the backbone of the polymer, terminally positioned on the backbone of the polymer, or a combination thereof, wherein these functional groups are capable of crosslinking with the crosslinkable functional groups (during the curing step) to produce a coating in the form of crosslinked structures. One of ordinary skill in the art would recognize that certain crosslinking functional group combinations would be excluded, since, if present, these combinations would crosslink among themselves (self-crosslink), thereby destroying their ability to crosslink with the crosslinkable functional groups. A workable combination of crosslinking functional groups refers to the combinations of crosslinking functional groups that can be used in coating applications excluding those combinations that would self-crosslink. One of ordinary skill in the art would recognize that certain combinations of crosslinking functional group and crosslinkable functional groups would be excluded, since they would fail to crosslink and produce the film forming crosslinked structures. The crosslinking component can comprise one or more crosslinking agents that have the crosslinking functional groups.

Typical crosslinking functional groups can include hydroxyl, thiol, isocyanate, thioisocyanate, acid or polyacid, acetoacetoxy, carboxyl, primary amine, secondary amine, epoxy, anhydride, ketimine, aldimine, melamine, orthoester, orthocarbonate, cyclic amide or a workable combination thereof.

It would be clear to one of ordinary skill in the art that certain crosslinking functional groups crosslink with certain crosslinkable functional groups. Examples of paired combinations of crosslinkable and crosslinking functional groups can include: (1) ketimine functional groups crosslinking with acetoacetoxy, epoxy, or anhydride functional groups; (2) isocyanate, thioisocyanate and melamine functional groups each crosslinking with hydroxyl, thiol, primary and secondary amine, ketimine, or aldimine functional groups; (3) epoxy functional groups crosslinking with carboxyl, primary and secondary amine, ketimine, or anhydride functional groups; (4) amine functional groups crosslinking with acetoacetoxy functional groups; (5) polyacid functional groups crosslinking with epoxy or isocyanate functional groups; and (6) anhydride functional groups generally crosslinking with epoxy and ketimine functional groups.

The term “vehicle”, “automotive”, “automobile”, “automotive vehicle”, or “automobile vehicle” refers to an automobile such as car, van, mini van, bus, SUV (sports utility vehicle); truck; semi truck; tractor; motorcycle; trailer; ATV (all terrain vehicle); pickup truck; heavy duty mover, such as, bulldozer, mobile crane and earth mover; airplanes; boats; ships; and other modes of transport that are coated with coating compositions.

This disclosure is directed to a process for producing a coating composition. The process can comprise the steps of:

(a) providing a first crosslinkable component comprising a first set of one or more film forming polymers and one or more organic solvents, said first crosslinkable component comprises in a range of from 10% to 80% weight percent of said one or more organic solvents, percentage based on the total weight of said first crosslinkable component;

(b) providing a second crosslinkable component comprising a second set of one or more film forming polymers and water, said second crosslinkable component comprises in a range of from 10% to 80% weight percent of water, percentage based on the total weight of said second crosslinkable component;

(c) providing a polytrimethylene ether glycol having a Mn (number average molecular weight) in a range of from 100 to 490; and

(d) producing said coating composition by mixing said first crosslinkable component, said second crosslinkable component, said polytrimethylene ether glycol, a crosslinking component, and optionally, an additive component.

The first crosslinkable component (a) and the second crosslinkable component (b) can be mixed at a mixing ratio (a) : (b) in a range of from 8:1 to 1:8. In one example, the mixing ratio can be in a range of from 4:1 to 1:4. In another example, the mixing ratio can be in a range of from 3:1 to 1:3. In yet another example, the mixing ratio can be in a range of from 2:1 to 1:2. The mixing ratio can be any values as a continuous range within any of the aforementioned ranges. For instance, the mixing ratio can be 3.95:1 in one example, 1:4.1 in another example, and 2:4.35 in yet another example.

The polytrimethylene ether glycol can be mixed with any of the crosslinkable component, or mixed together with all of the components. In one example, at least a portion of said polytrimethylene ether glycol can be mixed with the first crosslinkable component prior to mixing with said second crosslinkable component, said crosslinking component, and optionally, said additive component. In another example, at least a portion of the polytrimethylene ether glycol can be mixed with said second crosslinkable component prior to mixing with said first crosslinkable component, said crosslinking component, and optionally, said additive component. In yet another example, all components can be mixed at the same time.

At least one of the first crosslinkable component and the second crosslinkable component can further comprise one or more pigments. In one example, the first crosslinkable component can comprise one or more pigments. In another example, the second crosslinkable component can comprise one or more pigments. In yet another example, both the first and the second crosslinkable components can comprise one or more pigments. In a further example, none of the first or the second crosslinkable components comprises pigments.

At least one of the first crosslinkable component and the second crosslinkable component can comprise one or more crosslinkable functional groups. Any of the aforementioned crosslinkable functional groups can be suitable. The functional groups can be selected from hydroxyl groups; amine groups, such as primary amine, secondary amine or a combination thereof; epoxy groups; or carboxyl groups. A workable combination of the crosslinkable functional groups can also be suitable. A workable combination of crosslinkable functional groups refers to the combinations of crosslinkable functional groups that can be used in coating applications excluding those combinations that would self-crosslink. In one example, at least one or both of the crosslinkable components can comprise a combination of hydroxyl and amine functional groups.

The crosslinking component comprises one or more crosslinking functional groups. Aforementioned crosslinking functional groups can be suitable. In one example, the crosslinking functional groups can be selected from isocyanate groups, melamine groups, or a combination thereof. In another example, the crosslinking functional groups can be isocyanate groups.

The crosslinking component can comprise one or more crosslinking agents selected from aliphatic polyisocyanates, cycloaliphatic polyisocyanates, aromatic polyisocyanates, trifunctional isocyanates, isocyanate adducts, or a combination thereof. The crosslinking agent can also be selected from isophorone diisocyanate, toluene diisocyanate, hexamethylene diisocyanate, diphenylmethane diisocyanate, triphenyl triisocyanate, benzene triisocyanate, toluene triisocyanate, the trimer of hexamethylene diisocyanate, or a combination thereof. Other aliphatic, cycloaliphatic and aromatic polyisocyanates, including tri-functional isocyanates and trimers of diisocyanates, can also be suitable.

Other suitable crosslinking components can include melamine formaldehyde, benzoguanamine formaldehyde, and urea formaldehyde.

A silane crosslinking component can also be suitable. One example of silane crosslinking component can be an aminofunctional silane crosslinking agent. Examples of suitable aminofunctional silanes can include aminomethyltriethoxysilane, gamma-aminopropyltrimethoxysilane, gamma-aminopropyltriethoxysilane, gamma-aminopropylmethyldiethoxysilane, gamma-aminopropylethyldiethoxysilane, gamma-aminopropylphenyldiethoxyysilane, N-beta(aminoethyl)gamma-aminopropyltrimethoxysilane, delta-aminobutyltriethoxysilane, delta-aminobutylethyldiethoxysilane and diethylene triamino propylaminotrimethoxysilane. Preferred are N-beta(aminoethyl)gamma-aminopropyltrimethoxysilane commercially sold as Silquest® A 1120 and diethylene triamino propylaminotrimethoxysilane that is commercially sold as Silquest® A 1130. Both of theses silanes are sold by OSi Specialties, Inc. Danbury, Conn., under respective registered trademarks.

When an amino silane crosslinking agent is used, additional amino functional curing agents, such as, primary, secondary and tertiary amines, that are known in the art can be added. Typically, aliphatic amines containing a primary amine group, such as, diethylene triamine, and triethylene tetramine can be added. Tertiary amines, such as, tris-(dimethyl aminomethyl)-phenol can also be used.

The first set of one or more film forming polymers can comprise polymers selected from one or more acrylic polymers, one or more polyester polymers, one or more polyesterurethanes, one or more polyetherurethanes, one or more poly(meth)acrylamides, one or more polyepoxides, one or more polycarbonates, or a combination thereof.

The second set of one or more film forming polymers can comprise polymers selected from one or more acrylic polymers, one or more polyester polymers, one or more polyesterurethanes, one or more polyetherurethanes, one or more poly(meth)acrylamides, one or more polyepoxides, one or more polycarbonates, or a combination thereof.

The second set of one or more film forming polymers can comprise polymers selected from one or more water soluble or water dispersible acrylic polymers, one or more water soluble or water dispersible polyester polymers, or a combination thereof.

The acrylic polymer can have a weight average molecular weight (Mw) of about 1,000 to 100,000 and can contain functional groups or pendant moieties such as, for example, hydroxyl, amino, amide, glycidyl, silane, carboxyl groups or any other aforementioned crosslinkable functional groups. These acrylic polymers can be straight chain polymers or copolymers, branched polymers or copolymers, block copolymers, or graft copolymers. In one example, the one or more crosslinkable functional groups can be selected from hydroxyl groups, carboxyl groups, glycidyl groups, amino groups, silane groups, or a workable combination thereof.

The acrylic polymers can be polymerized from a plurality of unsaturated monomers, such as acrylates, methacrylates, or derivatives thereof, or any monomers suitable for acrylic polymers that are known to or developed by those skilled in the art. One or more of the unsaturated monomers can have crosslinkable functional groups or pendant moieties selected from hydroxyl groups, carboxyl groups, glycidyl groups, amino groups, silane groups, or a workable combination thereof. Examples of suitable unsaturated monomers can include linear alkyl(meth)acrylates, cyclic or branched alkyl(meth)acrylates, such as isobornyl(meth)acrylate, styrene, alpha methyl styrene, vinyl toluene, (meth)acrylonitrile, and (meth)acryl amides. Monomers can have crosslinkable functional groups. Unsaturated monomers that do not contain additional functional groups can also be suitable, for example, vinyl ethers, such as, isobutyl vinyl ether and vinyl esters, such as, vinyl acetate, vinyl propionate, vinyl aromatic hydrocarbons, preferably those with 8 to 9 carbon atoms per molecule. Examples of such monomers can include styrene, alpha-methylstyrene, chlorostyrenes, 2,5-dimethylstyrene, p-methoxystyrene, and vinyl toluene.

The acrylic polymers of this disclosure can generally be polymerized by free-radical copolymerization using conventional processes well known to those skilled in the art, for example, bulk, solution or bead polymerization, in particular by free-radical solution polymerization using free-radical initiators. Acrylic polymers produced via other polymerization processes can also be suitable.

The acrylic polymer can contain (meth)acrylamides. Typical examples of such acrylic polymers can be polymerized from monomers including (meth)acrylamide. In one example, such acrylic polymer can be polymerized from (meth)acrylamide and alkyl(meth)acrylates, hydroxy alkyl(meth)acrylates, (meth)acrylic acid and one of the aforementioned olefinically unsaturated monomers.

Acrylourethanes also can be suitable for the crosslinkable component. Typical useful acrylourethanes can be formed by reacting the aforementioned acrylic polymers with an organic polyisocyanate. Generally, an excess of the acrylic polymer can be used so that the resulting acrylourethane can have terminal acrylic segments having reactive groups as described above. These acrylourethanes can have reactive end groups and/or pendant groups such as hydroxyl, carboxyl, amine, glycidyl, amide, silane or mixtures of such groups. Useful organic polyisocyanates are described hereinafter as the crosslinking component but also can be used to form acrylourethanes useful in this invention. Examples of typically useful acrylourethanes can include those disclosed in Stamegna et al. U.S. Pat. No. 4,659,780.

The polyester polymers can be saturated or unsaturated and optionally, may be modified with fatty acids. The polyester polymers can be the esterification product of one or more polyhydric alcohols, such as, alkylene diols and glycols; monocarboxylic acids and a polycarboxylic acids or anhydrides thereof, such as, dicarboxylic and/or tricarboxylic acids or tricarboxylic acid anhydrides. The polyester polymers can have one or more aforementioned crosslinkable functional groups. The polyester polymers can be linear or branched.

The polyesterurethanes can be formed by reacting the aforementioned polyesters with an organic polyisocyanate. Generally, an excess of the polyester is used so that the resulting polyesterurethane has terminal polyester segments having reactive hydroxyl groups. Carboxy functional polyesterurethanes can also be used. Useful organic polyisocyanates are described hereinafter as the crosslinking component but can be used to form polyesterurethanes useful in this invention. Examples of typically useful coating compositions that utilize polyesterurethanes can include those disclosed in U.S. Pat. No. 5,122,522.

The polycarbonates can be esters of carbonic acid which are obtained by the reaction of carbonic acid derivatives, e.g., diphenyl carbonate or phosgene with polyols, preferably diols. Suitable diols can be any of those mentioned above.

The polyetherurethanes can be the reaction product of a polyetherpolyol and/or polylactonepolyol and an organic polyisocyanate.

The polyepoxides can be poly epoxy hydroxy ether resins having 1,2-epoxy equivalency of about two or more, that is, polyepoxides that have on an average basis two or more epoxy groups per molecule. Preferred polyepoxides are polyglycidyl ethers of cyclic polyols. Particularly preferred are polyglycidyl ethers of ployhydric phenols, such as, bisphenol A or bisphenol F. Such polyepoxides can be produced by the etherification of polyhydric phenols with epihalohydrin or dihalohydrin, such as, epichlorohydrin or dichlorohydrin in the presence of alkali. Examples of useful polyhydric phenols are 2,bis-(4-hydroxyphenyl)ethane, 2-methyl-1,1-bis-(4-hydroxyphenyl)propane and the like. Besides polyhydric phenols, other cyclic polyols can be used to prepare the polyglycidyl ethers, such as, alicyclic phenols, particularly, cycloaliphatic polyols, and hydrogenated bisphenol A.

The polyepoxides can be chain extended with polyether or polyester polyols, such as, polycaprolactone diols and with ethoxylated bisphenol A.

The poly(meth)acrylamides can be, such as, polymers of (meth)acrylamide and alkyl(meth)acrylates, hydroxy alkyl(meth)acrylates, (meth)acrylic acid and or one of the aforementioned ethylenically unsaturated polymerizable monomers.

The polymers can have one or more crosslinkable functional groups that can be selected from hydroxyl groups, carboxyl groups, glycidyl groups, amino groups, silane groups, or a combination thereof. The one or more functional groups can be from monomers that are used to produce the polymer, or be added to or modified on the polymer after polymerization. When more than one polymer is present in the coating composition, the crosslinkable functional groups can be on one or more of the polymers. In one example, the coating composition can comprise acrylic polymers. In another example, the coating composition can comprise polyesters. In yet another example, the coating composition can comprise acrylic polymers and polyesters. The crosslinkable functional groups can be on the acrylic polymers, the polyesters, or both the acrylic polymers and the polyesters.

The polytrimethylene ether glycol can be prepared by an acid-catalyzed polycondensation of 1,3-propanediol (herein referred to as “PDO”), which is also synonymous to “trimethylene glycol”, such as described in U.S. Pat. Nos. 6,977,291 and 6,720,459. The polytrimethylene ether glycol can also be prepared by a ring opening polymerization of a cyclic ether, oxetane, such as described in J. Polymer Sci., Polymer Chemistry Ed. 28, 449 to 444 (1985). The polycondensation of 1,3-propanediol is preferred over the use of oxetane since the diol is a less hazardous, stable, low cost, commercially available material and can be prepared by use of petro chemical feed-stocks or renewable resources.

A bio-route via fermentation of renewable resources can be used to obtain the 1,3-propanediol (PDO). One example of the renewable resources is corn since it is readily available and has a high rate of conversion to 1,3-propanediol and can be genetically modified to improve yields to the 1,3-propanediol. Examples of typical bio-route can include those described in U.S. Pat. No. 5, 686,276, US Patent No. 5,633,362 and U.S. Pat. No. 5,821,092. The 1,3-propanediol obtained from the renewable source and the coating compositions therefrom can be distinguished from their petrochemical derived counterparts on the basis of radiocarbon dating such as fraction of modern carbon (f_{M}), also know as 14C (f_{M}) and dual carbon-isotopic fingerprinting ¹³C/¹²C such as the one known as δ¹³C. The fraction of modern carbon f_{M} is defined by National Institute of Standards and Technology (NIST) Standard Reference Materials (SRMs) 4990B and 4990C, known as oxalic acids standards HOxI and HOxII, respectively.

The radiocarbon dating method usefully distinguishes chemically-identical materials, and apportions carbon in the polymer by source (and possibly year) of growth of the biospheric (plant) component. The isotopes, ¹⁴C and ¹³C, bring complementary information to this problem. The radiocarbon dating isotope (¹⁴C), with its nuclear half life of 5730 years, clearly allows one to apportion specimen carbon between fossil (“dead”) and biospheric (“alive”) feedstocks (Currie, L. A. “Source Apportionment of Atmospheric Particles,” Characterization of Environmental Particles, J. Buffle and H. P. van Leeuwen, Eds., 1 of Vol. I of the IUPAC Environmental Analytical Chemistry Series (Lewis Publishers, Inc) (1992) 3-74). The basic assumption in radiocarbon dating is that the constancy of 14C concentration in the atmosphere leads to the constancy of ¹⁴C in living organisms. When dealing with an isolated sample, the age of a sample can be deduced approximately by the relationship

t=(−5730/0.693)ln(A/A₀)

where t=age, 5730 years is the half-life of radiocarbon, and A and A₀ are the specific ¹⁴C activity of the sample and of the modern standard, respectively (Hsieh, Y., Soil Sci. Soc. Am J., 56, 460, (1992)). However, because of atmospheric nuclear testing since 1950 and the burning of fossil fuel since 1850, ¹⁴C has acquired a second, geochemical time characteristic. Its concentration in atmospheric CO₂, and hence in the living biosphere, approximately doubled at the peak of nuclear testing, in the mid-1960s. It has since been gradually returning to the steady-state cosmogenic (atmospheric) baseline isotope rate (¹⁴C/¹²C) of ca. 1.2×10⁻¹², with an approximate relaxation “half-life” of 7-10 years. (This latter half-life must not be taken literally; rather, one must use the detailed atmospheric nuclear input/decay function to trace the variation of atmospheric and biospheric ¹⁴C since the onset of the nuclear age.) It is this latter biospheric ¹⁴C time characteristic that holds out the promise of annual dating of recent biospheric carbon. ¹⁴C can be measured by accelerator mass spectrometry (AMS), with results given in units of “fraction of modern carbon” (f_{M}). The fundamental definition relates to 0.95 times the ¹⁴C/¹²C isotope ratio HOxI (referenced to AD 1950). This is roughly equivalent to decay-corrected pre-Industrial Revolution wood. For the current living biosphere, such as current plant materials or components derived from current plant materials, herein referred to as new carbon materials, f_{M}≈1.1.

The stable carbon isotope ratio (¹³C/¹²C) provides a complementary route to source discrimination and apportionment. The ¹³C/¹²C ratio in a given biosourced material is a consequence of the ¹³C/¹²C ratio in atmospheric carbon dioxide at the time the carbon dioxide is fixed and also reflects the precise metabolic pathway. Regional variations also occur. Petroleum, C₃ plants (the broadleaf), C₄ plants (the grasses), and marine carbonates all show significant differences in ¹³C/¹²C and the corresponding δ¹³C values. Furthermore, lipid matter of C₃ and C₄ plants analyze differently than materials derived from the carbohydrate components of the same plants as a consequence of the metabolic pathway. Within the precision of measurement, ¹³C shows large variations due to isotopic fractionation effects, the most significant of which for the present disclosure is the photosynthetic mechanism. The major cause of differences in the carbon isotope ratio in plants is closely associated with differences in the pathway of photosynthetic carbon metabolism in the plants, particularly the reaction occurring during the primary carboxylation, i.e., the initial fixation of atmospheric CO₂. Two large classes of vegetation are those that incorporate the “C₃” (or Calvin-Benson) photosynthetic cycle and those that incorporate the “C₄” (or Hatch-Slack) photosynthetic cycle. C₃ plants, such as hardwoods and conifers, are dominant in the temperate climate zones. In C₃ plants, the primary CO₂ fixation or carboxylation reaction involves the enzyme ribulose-1,5-diphosphate carboxylase and the first stable product is a 3-carbon compound. C₄ plants, on the other hand, include such plants as tropical grasses, corn and sugar cane. In C₄ plants, an additional carboxylation reaction involving another enzyme, phosphoenol-pyruvate carboxylase, is the primary carboxylation reaction. The first stable carbon compound is a 4-carbon acid, which is subsequently decarboxylated. The CO₂ thus released is refixed by the C₃ cycle.

Both C₄ and C₃ plants exhibit a range of ¹³C/¹²C isotopic ratios, but typical values are ca. −10 to −14 per mil (C₄) and −21 to −26 per mil (C₃) (Weber et al., J. Agric. Food Chem., 45, 2942 (1997)). Coal and petroleum fall generally in this latter range. The ¹³C measurement scale was originally defined by a zero set by pee dee belemnite (herein referred to as PDB) limestone, where values are given in parts per thousand deviations from this material. The “δ¹³C” values are in parts per thousand (per mil), abbreviated as %, and are calculated as follows:

$${δ}^{13} C ≡ \frac{( {}^{13} C / {}^{12} C ) sample - ( {}^{13} C / {}^{12} C ) standard}{( {}^{13} C / {}^{12} C ) standard} \times 1000 ° / °°$$

Since the PDB reference material (RM) has been exhausted, a series of alternative RMs have been developed in cooperation with the IAEA, USGS, NIST, and other selected international isotope laboratories. Notations for the per mil deviations from PDB is δ¹³C. Measurements are made on CO₂ by high precision stable ratio mass spectrometry (IRMS) on molecular ions of masses 44, 45 and 46.

Bio-derived 1,3-propanediol, and resulted compositions, such as polytrimethylene ether glycol, comprising bio-derived 1,3-propanediol, therefore, can be completely distinguished from their petrochemical derived counterparts on the basis of ¹⁴C (f_{M}) and dual carbon-isotopic fingerprinting, indicating new compositions of matter. The ability to distinguish these products is beneficial in tracking these materials in commerce. For example, products comprising both “new carbon materials” and “old carbon materials” (for example, carbon materials from petroleum products) can be distinguished from products made only of “old carbon materials” by isotope profiles.

The polytrimethylene ether glycol can have a Mn in a range of from 100 to 650. In one example, the polytrimethylene ether glycol can have a Mn in a range of from 100 to 490. In another example, the polytrimethylene ether glycol can have a Mn in a range of from 200 to 490. In yet another example, the polytrimethylene ether glycol can have a Mn in a range of from 250 to 490. In yet another example, the polytrimethylene ether glycol can have a Mn in a range of from 100 to 310. In yet another example, the polytrimethylene ether glycol can have a Mn in a range of from 100 to 250. The polytrimethylene ether glycol suitable for this disclosure need to be within the aforementioned range of Mn that can be controlled by polymerization process to have polymers with desired range of Mn, fractionation of polymers to obtain polymers having desired Mn distribution, or a combination thereof. The polymerization can be controlled, for example by polymerization timing, reaction temperature, reaction pressure, or a combination thereof, to produce polymers having Mn within the aforementioned range.

The polytrimethylene ether glycol can be fractionated or unfractionated. The unfractionated polytrimethylene ether glycol can have un-polymerized monomers and polymerized oligomers or polymers, such as dimers, trimers, tetramers, and pentamers. In one example, the unfractionated polytrimethylene ether glycol can have, such as, 1,3-propanediol (PDO) monomers, dimers (also referred to as “trimethylene glycol dimers”, “1,3-propanediol dimers”, or “di(1,3-propanediol)”), trimers (also referred to as “trimethylene glycol trimers”), tetramers (also referred to as “trimethylene glycol tetramers”), pentamers (also referred to as “trimethylene glycol pentamers”), hexamers (also referred to as “trimethylene glycol hexamers”) and heptamers (also referred to as “trimethylene glycol heptamers”). The fractionated polytrimethylene ether glycol can have different contents based on fractionation. In one example, the fractionated polytrimethylene ether glycol can have PDO monomers, dimers, trimers, tetramers, and pentamers. In another example, the fractionated polytrimethylene ether glycol can have PDO dimers, trimers, tetramers, and pentamers. In yet another example, the fractionated polytrimethylene ether glycol can have trimers, tetramers, pentamers and hexamers. In further example, the fractionated polytrimethylene ether glycol can have tetramers, pentamers, hexamers and heptamers. The fractionated polytrimethylene ether glycol can comprise in a range of from 10% to 100% of trimethylene glycol dimers in one example, 20% to 100% of trimethylene glycol dimers in another example, 30% to 100% of trimethylene glycol dimers in yet another example, 40% to 100% of trimethylene glycol dimers in yet another example, in a range of from 50% to 100% of trimethylene glycol dimers in yet another example, all percentage based on the total weight of the polytrimethylene ether glycol.

The polytrimethylene ether glycol can include copolymers of polytrimethylene ether glycol that can also be suitable for the coating composition of this disclosure. Examples of such suitable copolymers of polytrimethylene ether glycol can be prepared by copolymerizing 1,3-propanediol with another diol, such as, ethane diol, 1,2-propanediol, hexane diol, 2-methyl-1,3-propanediol, 2,2-dimethyl-1,3-propanediol, trimethylol propane and pentaerythritol. In one example, the copolymers of polytrimethylene ether glycol can be polymerized from monomers have 1,3-propanediol in a range of from 50% to 99%. In another example, the copolymers of polytrimethylene ether glycol can be polymerized from monomers have 1,3-propanediol in a range of from 60% to 99%. In yet another example, the copolymers of polytrimethylene ether glycol can be polymerized from monomers have 1,3-propanediol in a range of from 70% to 99%.

The polytrimethylene ether glycol useful in the compositions and methods disclosed herein can contain small amounts of other repeat units, for example, from aliphatic or aromatic diacids or diesters, such as disclosed in U.S. Pat. No. 6,608,168. This type of trimethylene ether glycol oligomer can also be called a “random polytrimethylene ether ester”, and can be prepared by polycondensation of 1,3-propanediol reactant and about 10 to about 0.1 mole % of aliphatic or aromatic diacid or esters thereof, such as terephthalic acid, isophthalic acid, bibenzoic acid, naphthalic acid, bis(p-carboxyphenyl)methane, 1,5-naphthalene dicarboxylic acid, 2,6-naphthalene dicarboxylic acid, 2,7-naphthalene dicarboxylic acid, 4,4′-sulfonyl dibenzoic acid, p-(hydroxyethoxy)benzoic acid, and combinations thereof, and dimethyl terephthalate, bibenzoate, isophthlate, naphthalate and phthalate; and combinations thereof. Of these, terephthalic acid, dimethyl terephthalate and dimethyl isophthalate are preferred.

The polytrimethylene ether polymers with functional groups other than hydroxyls end groups can also be used. Examples of polytrimethylene ether glycol oligomers with amine and ester end functional groups can include those disclosed in U.S. Patent Publication No. 2008/0108845 with Ser. No. 12/704,867.

The polytrimethylene ether glycol can have in a range of from 10% to 100% of trimethylene glycol dimers, percentage based on the total weight of the polytrimethylene ether glycol. The polytrimethylene ether glycol can have in a range of from 10% to 100% of trimethylene glycol dimers in one example, in a range of from 20% to 100% of trimethylene glycol dimers in another example, in a range of from 30% to 100% of trimethylene glycol dimers in another example, and in a range of from 40% to 100% of trimethylene glycol dimers in a yet further example, or in a range of from 50% to 100% of trimethylene glycol dimers in yet another example, all percentage based on the total weight of the polytrimethylene ether glycol. Fractionation, distillation or other separation or purification techniques can be used to produce polytrimethylene ether glycol having desired contents of dimers, trimers, or tetramers, etc. Fractionation, distillation or other separation or purification techniques can also be used to remove undesired contents from polytrimethylene ether glycol.

The polytrimethylene ether glycol can be polymerized from bio-derived 1,3-propanediol. The polytrimethylene ether glycol can be polymerized from monomers comprising in a range of from 10% to 100% of bio-derived 1,3-propanediol in one example, in a range of from 20% to 100% of bio-derived 1,3-propanediol in another example, in a range of from 40% to 100% of bio-derived 1,3-propanediol in yet another example, in a range of from 60% to 100% of bio-derived 1,3-propanediol in yet another example, in a range of from 80% to 100% of bio-derived 1,3-propanediol in yet another example, and 100% of bio-derived 1,3-propanediol in a further example, all percentage based on the total weight of monomers used for polymerizing the polytrimethylene ether glycol.

The coating composition can comprise in a range of from 0.01% to 20% of the polytrimethylene ether glycol, percentage based on the total weight of the coating composition. The coating composition can comprise in a range of from 0.01% to 20% of the polytrimethylene ether glycol in one example, in a range of from 0.1% to 20% of the polytrimethylene ether glycol in another example, in a range of from 0.5% to 20% of the polytrimethylene ether glycol in yet another example, and in a range of from 1% to 20% of the polytrimethylene ether glycol in yet another example. In a further example, the coating composition can comprise in a range of from 0.01% to 20% of the trimethylene glycol dimers. In an even further example, the coating composition can comprise in a range of from 0.1% to 20% of the trimethylene glycol dimers. In a yet even further example, the coating composition can comprise in a range of from 0.5% to 20% of the trimethylene glycol dimers. In a yet even further example, the coating composition can comprise in a range of from 0.5% to 5% of the trimethylene glycol dimers. All percentages are based on the total weight of the coating composition.

The coating composition can comprise conventional coating additives. Examples of such additives can include wetting agents, leveling and flow control agents, for example, Resiflow®S (polybutylacrylate), BYK® 320 and 325 (high molecular weight polyacrylates), BYK® 347 (polyether-modified siloxane) under respective registered tradmarks, leveling agents based on (meth)acrylic homopolymers; rheological control agents; thickeners, such as partially crosslinked polycarboxylic acid or polyurethanes; and antifoaming agents. The additives can be used in conventional amounts familiar to those skilled in the art.

The coating composition of this disclosure can be used as a primer, a basecoat, a top coat, or a clearcoat. It can also be used as a single layer coat that can function as a primer, a basecoat and a top coat.

This disclosure is also directed to an article coated with the aforementioned process. The article can be a vehicle; a vehicle body part; a tool or machinery; a sport equipment, such as a ski or a bicycle; furniture; a building or a building unit; a home appliance, such as a refrigerator, a microwave oven, a TV, or a washer; or any other industrial or consumer items coated with a coating.

This disclosure is further directed to a process for producing a dry coating layer over a substrate, said process comprising the steps of:

(i) applying the coating composition of described above over said substrate to form a wet coating layer thereon; and

(ii) curing said wet coating layer at a temperature in a range of from 15° C. to 80° C. to form said dry coating layer.

The coating composition can be applied with conventional coating techniques or apparatus, such as rolling, dipping, or spraying. In one example, the wet coating layer can be formed by spraying.

The wet coating layer can be cured at the aforementioned temperature range for a time period in a range of from a few minutes to a few hours or days as determined necessary by those skilled in the art. The wet coating layer can be cured at a temperature in a range of from 15° C. to 80° C. in one example, in a range of from 15° C. to 60° C. in another example, in a range of from 15° C. to 50° C. in yet another example, in a range of from 15° C. to 40° C. in yet another example, or in a range of from 15° C. to 35° C. in a further example.

The substrate can be a vehicle, a vehicle body part, or a combination thereof. The substrate can also be selected from wood, concrete, metal, plastic, glass, paper, fiber, gypsum plaster, cement, stone, rock, brick, masonry, or a combination thereof.

Applicants unexpectedly discovered that in the presence of the polytrimethylene ether glycol, a solvent borne coating component and a waterborne coating component can be mixed to produce a low VOC coating composition. The low VOC coating composition can have a VOC level lower that that of the solvent borne coating component.

Applicants further unexpectedly discovered that the low VOC coating composition produced herein can be used to produce a dry coating layer having high gloss and shorter dry to touch time.

One advantage of the process disclosed herein is that it can be used to mix a solvent borne coating component with a waterborne coating component to produce a low VOC coating composition.

A further advantage of the process of this disclosure is that it can produce a coating composition that contains a component derived from a renewable resource.

### Testing Procedures

Dry Film Thickness—test method ASTM D4138.

Dry to touch time—Dry to touch time is determined by ASTM D1640.

Molecular weights Mw and Mn and the polydispersity (Mw/Mn) of the acrylic polymer and other polymers are determined by GPC (Gel Permeation Chromatography) using polystyrene standards and tetrahydrofuran as the solvent.

Gloss—measured with standard test method for specular gloss according to ASTM D 523.

### EXAMPLES

The present invention is further defined in the following Examples. It should be understood that these Examples, while indicating preferred embodiments of the invention, are given by way of illustration only. From the above discussion and these Examples, one skilled in the art can ascertain the essential characteristics of this invention, and without departing from the spirit and scope thereof, can make various changes and modifications of the invention to adapt it to various uses and conditions.

### Procedure 1

### Preparation of Low Molecular Weight Polytrimethylene Ether Glycol

Twelve kilogram (kg) renewably sourced 1,3-propanediol (PDO) monomers commercially available from DuPont Tate & Lyle Bioproducts, Wilmington, Del., USA, were added to a 20 L glass reactor equipped with a condenser and an agitator. The glass reactor was purged with N₂ at the rate 3 L/min. Triflic acid (trifluoromethanesulfonic acid) was added into the reactor to a final concentration of 0.1 wt % and the mixture was heated up to 180° C. with agitation set to 200 RPM to allow the acid-catalyzed polycondensation to proceed. The reaction volatiles were condensed in the condenser and the crude polymer product was retained in the reactor. Crude polymer samples were taken periodically for color and molecular weight analysis. Once the desired Mn was achieved, the polymerization was terminated by turning the heat down. An antioxidant, BHT (Butylated hydroxyl toluene), available from Aldrich, St. Louis, Mo., USA, was added to the crude polymer to a final concentration about 200 ppm. The polymer was neutralized by treating the crude polymer with XUS ion exchange resin, available from Dow Chemical, Midland, Mich., USA, in 2 stages. In the first stage, 2 weight parts of the XUS ion exchange resin and 98 weight parts of the crude polymer were mixed at a temperature of about 105° C. for about 1 hour. In the second stage, an additional 2 weight parts of the XUS ion exchange resin was added to the crude polymer and further mixed for additional 3 hours. Neutralization was conducted under sub-surface nitrogen sparging of 5 L/min and a mixing speed of 200 RPM. The product was filtered to remove the ion exchange resin. Filtration was done at 60° C. Once the product was free of solids, it was dried by heating to about 95° C., with sub-surface nitrogen sparging of about 10 L/min and mixing speed of 150 RPM.

The product had about 2.7% of 1,3-propanediol monomer, 15% 1,3-propanediol dimer (also referred to as “trimethylene glycol dimer”), 80% or more of other oligomers of 1,3-propanediol including trimer, tetramer, pentamer, hexamer, heptamer, etc., percentage based on the total weight of the product.

Calculated molecular weights (Mn) for the 1,3-propanediol oligomers are shown in Table 1.

TABLE 1
Molecular weight (Mn) of 1,3-propanediol oligomers.

| Polytrimethylene ether glycol | Calculated Mn |
|---|---|
| 1,3-propanediol dimer | 134 |
| 1,3-propanediol trimer | 192 |
| 1,3-propanediol tetramer | 250 |
| 1,3-propanediol pentamer | 308 |
| 1,3-propanediol hexamer | 366 |
| 1,3-propanediol heptamer | 424 |

### Coating Compositions and Coating Properties

Coating compositions of Example 1 (Exp) and Comparative Example (Comp) were prepared according to Table 2.

TABLE 2
Coating Compositions (parts in weight).

| Components | Comp | Exp |
|---|---|---|
| Waterborne crosslinkable component¹ | 25 | 25 |
| Solvent borne crosslinkable component² | 100 | 100 |
| Polytrimethylene Ether Glycol³ | 0 | 5 |
| Crosslinking component⁴ | 40 | 42 |
| Total | 165 | 167 |

¹Imron ® ZV HG-C ™ high gloss waterborne polyurethane enamel vlearcoat without Activator, available from E. I. du Pont de Nemours and Company, Wilmington, Delaware, U.S.A., under appropriate trademarks. Weight solid is about 75%. Calculated VOC: 0.0 lbs/gal.
²Imron ® Industrial Strength Ultra Low VOC polyurethane reduced gloss topcoat, Black (9T02 ™) available from E. I. du Pont de Nemours and Company, Wilmington, Delaware, U.S.A., under appropriate trademarks. Weight solid is about 62%. Calculated VOC: 0.3-2.3 lbs/gallon depending on whether or not a reducer is used.
³Low molecular weight polytrimethylene ether glycol from Procedure 1.
⁴FG-572 ® isocyanate activator, available from E. I. du Pont de Nemours and Company, Wilmington, Delaware, U.S.A., under appropriate trademarks.

The coating compositions were applied to galvanized steel panels, available as Cat No. HDG70G70U from ACT Panels, Hillsdale, Mich., by drawdown blade to a thickness of about 4 mils (about 0.10 mm) and cured at 75° F. (about 24° C.) and 50% relative humidity. Coating properties were measured according to the Testing Procedures. The results are shown in Table 3.

TABLE 3
Coating Properties.

| Property | Comp | Exp |
|---|---|---|
| Dry to Touch Time (hour) | 3 | 1 |
| 60° Gloss | 60 | 90 |

What is claimed is:

1. A process for producing a coating composition, said process comprising the steps of:
(a) providing a first crosslinkable component comprising a first set of one or more film forming polymers and one or more organic solvents, said first crosslinkable component comprises in a range of from 10% to 80% weight percent of said one or more organic solvents, percentage based on the total weight of said first crosslinkable component;
(b) providing a second crosslinkable component comprising a second set of one or more film forming polymers and water, said second crosslinkable component comprises in a range of from 10% to 80% weight percent of water, percentage based on the total weight of said second crosslinkable component;
(c) providing a polytrimethylene ether glycol having a Mn (number average molecular weight) in a range of from 100 to 490; and
(d) producing said coating composition by mixing said first crosslinkable component, said second crosslinkable component, said polytrimethylene ether glycol, a crosslinking component, and optionally, an additive component.

2. The process of claim 1, wherein said first crosslinkable component (a) and said second crosslinkable component (b) are mixed at a mixing ratio (a):(b) in a range of from 8:1 to 1:8.

3. The process of claim 1, wherein at least a portion of said polytrimethylene ether glycol is mixed with said first crosslinkable component prior to mixing with said second crosslinkable component, said crosslinking component, and optionally, said additive component.

4. The process of claim 1, wherein at least a portion of said polytrimethylene ether glycol is mixed with said second crosslinkable component prior to mixing with said first crosslinkable component, said crosslinking component, and optionally, said additive component.

5. The process of claim 1, wherein at least one of said first crosslinkable component and said second crosslinkable component further comprises one or more pigments.

6. The process of claim 1, wherein at least one of said first crosslinkable component and said second crosslinkable component comprises one or more crosslinkable functional groups selected from hydroxyl groups, amine groups, orthoester groups, orthocarbonate groups, cyclic amide groups, epoxy groups, or carboxyl groups.

7. The process of claim 1, wherein said crosslinking component comprises one or more crosslinkable functional groups selected from isocyanate groups, melamine groups, or a combination thereof.

8. The process of claim 1, wherein said first set of one or more film forming polymers comprises polymers selected from one or more acrylic polymers, one or more polyester polymers, one or more polyesterurethanes, one or more polyetherurethanes, one or more poly(meth)acrylamides, one or more polyepoxides, one or more polycarbonates.

9. The process of claim 1, wherein said second set of one or more film forming polymers comprises polymers selected from one or more acrylic polymers, one or more polyester polymers, one or more polyesterurethanes, one or more polyetherurethanes, one or more poly(meth)acrylamides, one or more polyepoxides, one or more polycarbonates.

10. The process of claim 1, wherein said second set of one or more film forming polymers comprises polymers selected from one or more water or water dispersible polyester polymers, or a combination thereof.

11. The process of claim 1, wherein said trimethylene glycol dimers is polymerized from bio-derived 1,3-propanediol.

12. The process of claim 1, wherein said coating composition comprises in a range of from 0.01% to 20% of the polytrimethylene ether glycol.

13. An article coated with the process of claim 1.

14. A process for producing a dry coating layer over a substrate, said process comprising the steps of:
(i) applying the coating composition of claim 1 over said substrate to form a wet coating layer thereon; and
(ii) curing said wet coating layer at a temperature in a range of from 15° C. to 80° C. to form said dry coating layer.

15. The process of claim 14, wherein said substrate is a vehicle, a vehicle body part, or a combination thereof.

16. The process of claim 14, wherein said substrate is selected from wood, concrete, metal, plastic, glass, paper, fiber, gypsum plaster, cement, stone, rock, brick, masonry, or a combination thereof.
